(19) United States
(12) Patent Application Publication
(10) Pub. No.: US 2011/0023045 A1
(43) Pub. Date: Jan. 27, 2011

(54) Targeted communication to resource consumers

(75) Inventors: Daniel J. Yates, Washington, DC (US); Alexander D. Laskey, Berkeley, CA (US)

Correspondence Address: Sunstein Kann Murphy & Timbers LLP, 125 SUMMER STREET, BOSTON, MA, 02110-1618, US

(73) Assignee: Positive Energy, Inc.

(21) Appl. No.: 12/009,639

(22) Filed: Jan. 18, 2008

Related U.S. Application Data
(60) Provisional application No. 61/008,740, filed on Dec. 21, 2007.

(51) Int. Cl. G06F 9/50

(52) U.S. Cl. 718/104

(57) ABSTRACT

A method of communicating to a consumer is disclosed. The consumer's usage of a resource is compared to a relevant cohort's usage of the resource. Based at least in part on a result of the comparison, a message is selected to be provided to the consumer.

### CROSS REFERENCE TO OTHER APPLICATIONS

This application claims priority to U.S. Provisional Patent Application No. 61/008,740 (Attorney Docket No. POSIP002+) entitled TARGETED COMMUNICATION TO RESOURCE CONSUMERS filed Dec. 21, 2007 which is incorporated herein by reference for all purposes.

### BACKGROUND OF THE INVENTION

Persuading consumers to moderate their consumption of resources is useful to reduce the waste of said resources, to reduce overall or peak demand of said resources, to make efficient use of money, and to preserve the planet's natural environment. Resource distribution companies, such as utilities, have included reports in resource bills that attempt to persuade consumers to moderate their consumption based on a comparison with the same resource billing account (“resource account”) in a different year (e.g., you consumed X1 units as compared to X0 units for the same period last year), or with different resource accounts based on geography (e.g., you consumed Y(n) units as compared to an average consumption for the 415 area code of Y̅).

Resource distribution companies have communicated conservation messages and/or information to consumers, e.g., in bills and/or separate mailings, but typically the same message has been sent to all users to the resource in a geographic and/or service area.

### BRIEF DESCRIPTION OF THE DRAWINGS

Various embodiments of the invention are disclosed in the following detailed description and the accompanying drawings.

FIG. 1 illustrates a system for communicating a consumer's usage of a resource.

FIG. 2 is a block diagram illustrating an embodiment of a system for communicating a consumer's usage of a resource.

FIG. 3 is a block diagram illustrating an embodiment of a system for communicating to a consumer.

FIG. 4A is a diagram illustrating an example of communicating to a consumer using a standalone report.

FIG. 4B is a diagram illustrating an example of communicating to a consumer using an integrated bill.

FIG. 5 is a flowchart illustrating an embodiment of a process for communicating a consumer's usage of a resource.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

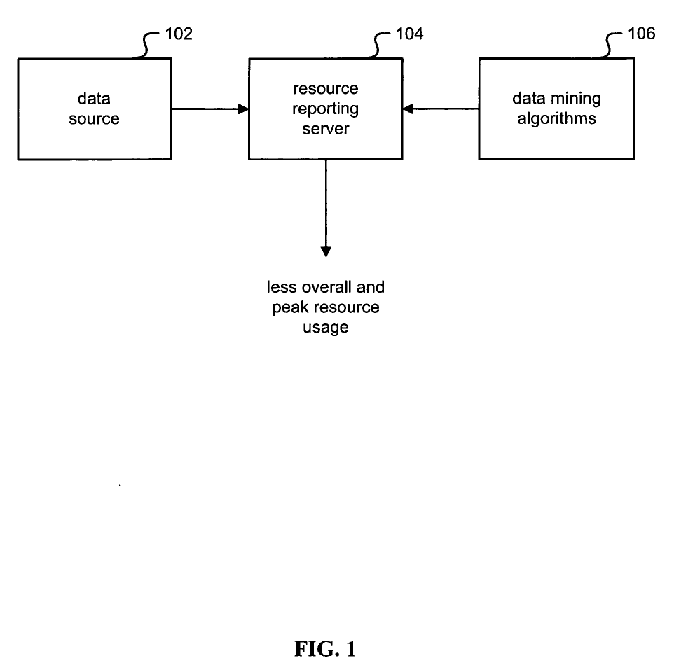

FIG. 1 illustrates a system for communicating a consumer's usage of a resource. In the example shown, one or more data sources 102 are coupled to a resource reporting server 104, along with one or more data mining algorithms 106, to motivate less overall and peak resource usage.

New technology such as Advanced Meter Infrastructure (“AMI”) allows resource distribution companies to collect consumer resource usage data several times daily, in lieu of the current standard of monthly resource use reading. Data such as AMI data can be further analyzed for more detailed and accurate assessments of consumer resource consumption behavior and installed appliances and resource consumptive devices in the home.

Data from data source 102 is comprised by one or more of:
geographic information systems (“GIS”) data, including locations from the global positioning system (“GPS”), geographic regions represented as areas surrounding (or within a fixed radius of) specific addresses, and latitude and longitude pairs;
weather data, including historical and current statistics on temperature, humidity, apparent temperature, and climate for a geographic region or aggregate;
demographic data, including address data (a street, city, county, state/province, zip+4/postal code, and/or country), designated market areas (“DMAs”), major metropolitan areas, combined statistical areas (“CSAs”), income data from private data providers, level of concern for the environment per household, status of household as homeowner or renter, and voter registration;
housing data, including government and county data recording the square foot/meter or plan area of a consumer's home and the date of construction of a consumer's home, housing orientation and shade cover and assessed value of the house;
census data including household data: ages, ethnicities, education levels, number of births and children, level of computer usage, household income, location data, census tracts, block groups, and blocks;
billing data, including a consumer's usage or readings of: electricity, gas, water, sewer, waste, wastewater, garbage, recycling, phone, and/or network broadband access, and corresponding multiple readings per day of these utilities with advanced meters where available;
resource distribution company data on consumer interaction including customer satisfaction data and response rates to past marketing efforts online, on paper, and via the telephone; and
financial data, including a consumer's participation in rebate programs, discounted offers, and coupons from local municipal, county/prefecture and/or provincial/state governments, and businesses, and historical information on default and payment rates to resource distribution companies.

The data mining algorithms 106 are comprised of custom targeting algorithms that filter a plurality of data points across the data sources 102 to persuade a consumer to moderate resource consumption through peer comparison, and adaptive algorithms that react to feedback from the data sources 102.

In some embodiments, a custom targeting algorithm segments customer energy use through analysis of the energy use signal over time normalized to the most relevant peer group. The most relevant peer group is determined by a plurality of variables. In some embodiments the plurality of variables include proximity, house size, and house age. A normalizing process may be used to attenuate noise from the comparison so as to highlight the type of usage profile.

For sources with data collected on the order of months, users can be segmented according to their annual usage profile. Analysis may include determining heavy air conditioner usage or heavy appliance usage. For sources with data collected on the order of days or hours, data may be analyzed at a detailed level and determine specific issues such as problematic appliances or lighting contribution.

The resource reporting server 104 uses targeted direct marketing techniques to persuade a consumer to moderate resource consumption using one or more of these techniques:
segmentation of the set of consumers into different subsets based upon a plurality of demographic variables;
segmentation of the set of consumers into different subsets based upon analysis and characterization of energy usage normalized to relevant peer groups;
prioritization of the messages based upon their historical rate of uptake multiplied by the expected energy savings value of the program;
offers and services for resource efficient products discounted by private industry through rebates, coupons, and other discounts to support government subsidies of efficient products;
high quality design (using high quality print design, high quality web graphics, video, audio and other multimedia) for all data reports, dynamically customized for each consumer;
integration with an Internet site or website for online and offline viewing of reports;
scalability of report format to hundreds of millions of reports;
enabling efficacy tracking of hundreds of simultaneous marketing and messaging campaigns; and
straightforward integration with resource and/or utility databases.

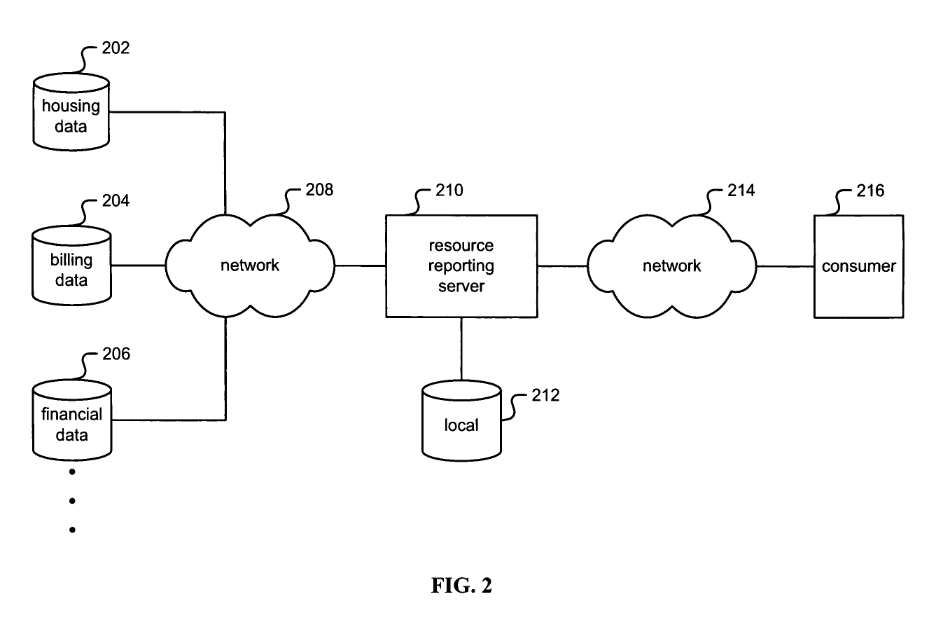

FIG. 2 is a block diagram illustrating an embodiment of a system for communicating a consumer's usage of a resource. In some embodiments, the system of of FIG. 2 is included in FIG. 1. In the example shown, three data sources including housing data source 202, billing data source 204, and financial data source 206 are coupled through network 208 to resource reporting server 210. The resource reporting server 210 has a local database 212, and is also coupled through network 214 to consumer resource accounts 216. The data sources 202, 204, 206 and local database 212 are examples of a “data store” which contain resource usage information. In some embodiments the data store is a disk, tape, or storage array. In some embodiments, the data store may be one or more remote databases, one or more local databases, or span both remote and local databases.

Housing data 202 may include government and county data recording the square foot/meter or plan area of a consumer's home, the date of construction of a consumer's home, the number of floors, the presence of a garage, the presence of a pool, the assessed value of the home, and permits issued for past renovations. Billing data 204 may include a consumer's usage or readings of: electricity, gas, water, sewer, waste, wastewater, garbage, recycling, phone, and/or network broadband access, and corresponding multiple readings per day of these utilities with advanced meters where available. Financial data 206 may include a consumer's participation in rebate programs from local municipal, county/prefecture and/or provincial/state governments, and businesses.

Network 208 and network 214 may be a public or private network and/or combination thereof, for example the Internet, an Ethernet, serial/parallel bus, intranet, Local Area Network (“LAN”), Wide Area Network (“WAN”), and other forms of connecting multiple systems and/or groups of systems together.

Resource reporting server 210 may consist of one or more servers, including server 104, dedicated to processing data mining algorithms 106 to moderate resource usage of consumer 216. In some embodiments server 210 will have a local database 212 to record historical data, execute data mining algorithms 106, and/or record additional data. Consumer 216 will act and react to reports or websites from resource reporting server 210 by adjusting resource consumption and/or participating in programs such as rebate programs. These consumer reactions will directly or indirectly adjust the data in data sources 102, for example billing data source 204, and the resource reporting server 210 will dynamically adjust to the said consumer reactions.

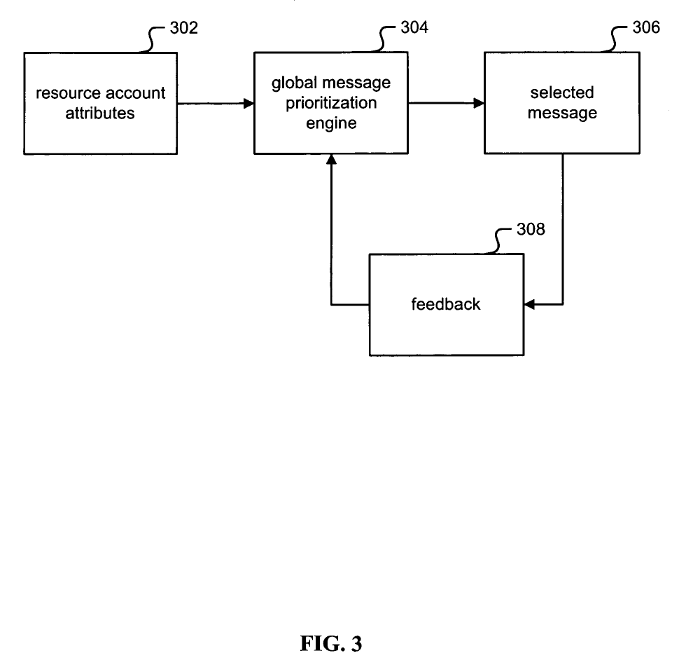

FIG. 3 is a block diagram illustrating an embodiment of a system for communicating to a consumer. In the example shown, resource account attributes 302 are input to global message prioritization engine 304. In some embodiments, global message prioritization engine 304 may be a part of resource reporting server 210. Based on resource account attributes 302, the global message prioritization engine 304 will determine one or more selected messages 306 to be communicated to the consumer. After a period of time, feedback 308 will be gathered to dynamically adjust global message prioritization engine 304 for the next selected message 306.

In some embodiments, resource account attributes 302 include data from data sources 102 and the result of a comparison between resource usage of a relevant cohort and resource usage of the customer. A relevant cohort is a plurality of resource accounts sharing a common statistical factor with the consumer, that when compared to the consumer suggests to the consumer that their resource usage could be moderated further.

For example, a relevant cohort could be “3-bedroom houses on the consumer's street”. The resource account attributes 302 may include the fact that over a twelve month average, the consumer used 46% more electrical energy than the relevant cohort. Another example of a resource account attributes 302 includes the fact that one or more members of the relevant cohort recently participated in a air conditioner efficiency rebate program, or that the consumer's electricity usage time-value curve coupled with a temperature time-value curve indicates that the consumer's electricity usage is higher than average during hot weather. In some embodiments, a similar analysis would determine whether a consumer's electricity usage increases as a percentage of daily use more than average during hot weather.

In some embodiments, global message prioritization engine 304 requests, receives, and makes further calculations on resource account attributes 302. The global message prioritization engine 304 takes a global list of possible candidate messages and filters out and prioritizes messages to be sent to the consumer.

For example, the long global list of possible candidate messages may include a message to “install efficient central air conditioning using an existing government rebate”, a message to “install a timer for a car engine block heater during winter”, and a message to “call 811 before digging”. In the above example where the input resource account attributes 304 include a consumer's electricity usage is higher than average during hot weather, and that 19% of the relevant cohort have participated in an air conditioner rebate program, the global message prioritization engine 104 may prioritize the “install efficient central air conditioning using an existing government rebate” candidate message higher than “install a timer for a car engine block heater during winter” candidate message, especially if a further resource account attribute 304 indicates the consumer and relevant cohort live in a state where there are no winters below 30 degrees Fahrenheit.

In some embodiments the global message prioritization engine 304 assigns to each of at least a subset of a plurality of candidate messages a priority and selects based at least in part on the assigned priorities a number of selected messages 306, wherein the number of messages selected corresponds to a limited number of messages to be presented to the consumer.

Feedback 308 is used to determine the effectiveness of the algorithms used in global message prioritization engine 304 to determine appropriate selected messages 306. In some embodiments, feedback 308 includes usage of at least the relevant cohort and the consumer, to see if any or no change has occurred since the last communication. In some embodiments, feedback 308 includes consumer action taken with respect to the message, for example if a consumer has since participated in an air conditioner rebate program. In some embodiments, feedback 308 includes an estimate of future usage of the relevant cohort and the consumer based on previous consumer action participation, for example if the rebate program were sent to 50,000 users, 800 used the rebate and from those 780 showed reduced consumption.

In some embodiments, if a specified percentage of consumers do not participate in a rebate program, the priority of a message associated with the rebate program is or may be reduced.

In some embodiments, an algorithm calculating the overall impact of reduced resource consumption is used to prioritize effectiveness of messages. Based upon feedback, estimates are made as to the rate of impact per consumer of the message and the scale of impact per consumer. Multiplied together an aggregate estimate of overall message impact on reducing resource consumption is calculated.

In some embodiments, the aforementioned aggregated resource reduction impact of messages is combined with the rate of private industry participation with offers that reduce government need to subsidize an efficient product. This prioritization results in a set of messages that increase overall resource reduction at the most cost effective rate for the government providing the marketing and subsidy programs for the resource reduction.

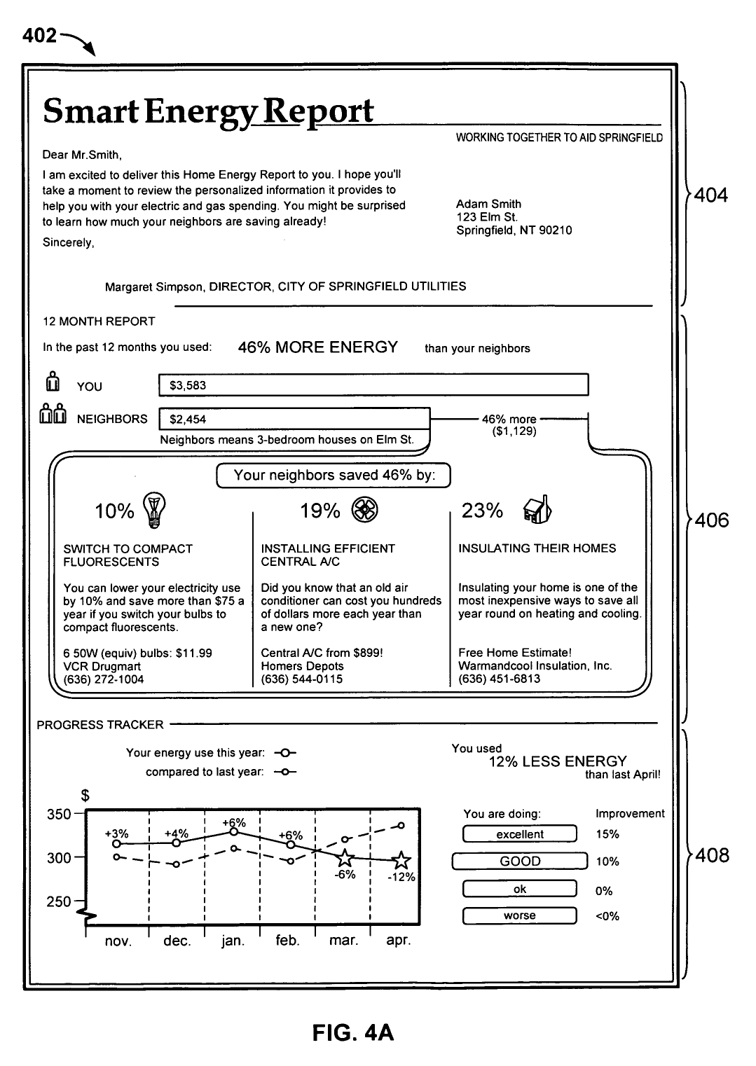

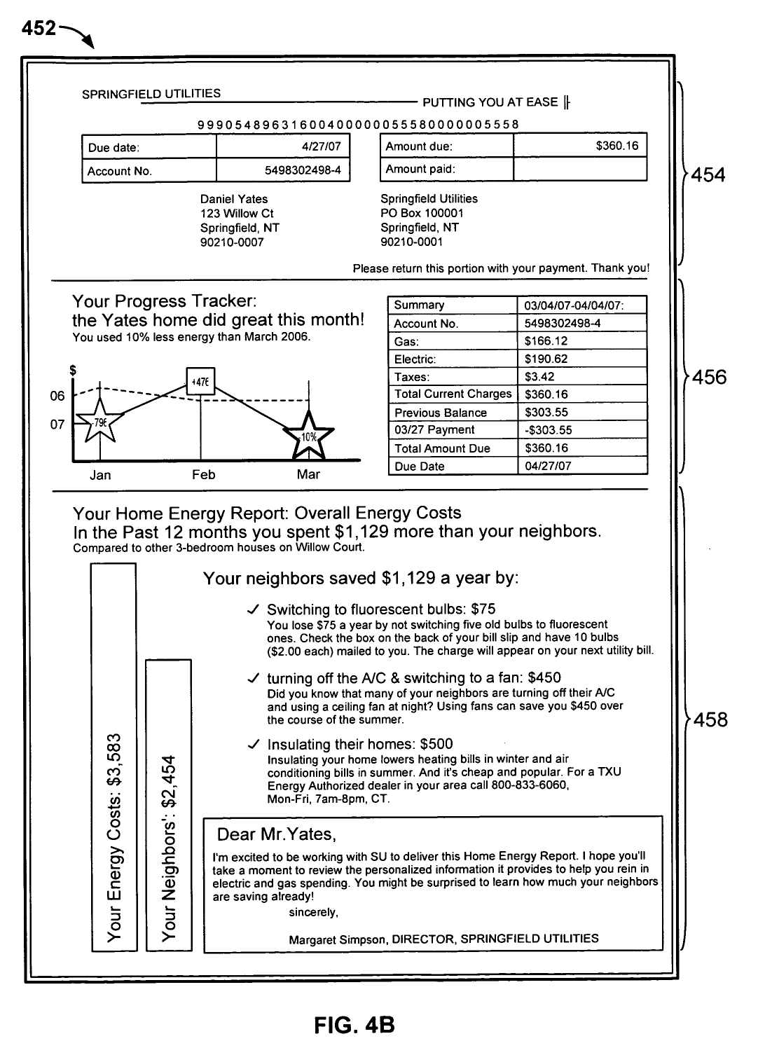

FIG. 4A is a diagram illustrating an example of communicating to a consumer using a standalone report. The standalone report 402 would be either sent separately to a consumer or placed in the same container as a resource bill. In some embodiments, the standalone report 402 is either sent to the consumer by mail or electronically as an email or on a website. The standalone report 402 includes at least three sections; a mailer window 404, a dynamic graph 406 containing the selected messages, and analytical section 408.

The dynamic graph 406 shows the comparison between the consumer and the relevant cohort, and displays selected messages on how to moderate the consumer's resource usage. In the example shown in FIG. 4A, there is space for only three selected messages, in a left-to-right priority order:
the top selected message is that 10% of the relevant cohort conserved resources by switching to fluorescent light bulbs;
the second selected message is that 19% of the relevant cohort conserved resources by participating in an efficient air conditioner program; and
the last selected message is that 23% of the relevant cohort conserved resources by insulating their homes.

The analytical section 208 may include charts and graphs to compare other resource usage statistics to encourage a consumer to moderate resource usage.

FIG. 4B is a diagram illustrating an example of communicating to a consumer using an integrated bill. The integrated bill 452 would be sent instead of the traditional resource bill. The integrated bill 452 is comprised of at least three sections; a mailer window and payment stub 454, an analytical section and bill summary 456, and a dynamic graph 458 containing the selected messages. The analytical section and bill summary 456 may include charts and graphs to compare other resource usage statistics to encourage a consumer to moderate resource usage.

The dynamic graph 458 shows the comparison between the consumer and the relevant cohort, and displays selected messages on how to moderate the consumer's resource usage. In the example shown in FIG. 4B, there is space for only three selected messages, in a top-to-bottom priority order:
the top selected message is that members of the relevant cohort saved $75/year by switching to fluorescent light bulbs;
the second selected message is that members of the relevant cohort saved $450/year by turning off air conditioning and switching to a fan; and
the last selected message is that members of the relevant cohort saved $500/year by insulating their homes.

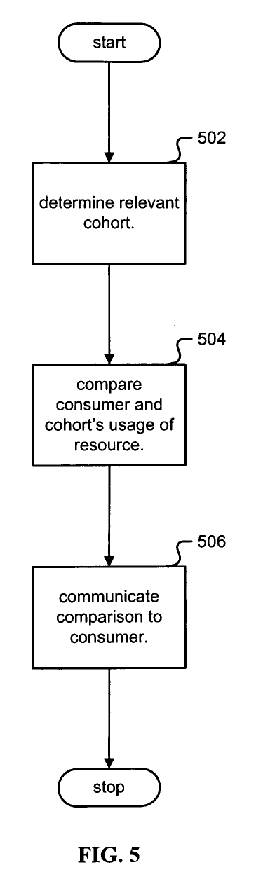

FIG. 5 is a flowchart illustrating an embodiment of a process for communicating a consumer's usage of a resource. The process may be implemented in resource reporting server 104.

In step 502, a relevant cohort is determined. In some embodiments this step may be omitted if a relevant cohort is pre-calculated or determined externally.

In some embodiments, determining the relevant cohort comprises selecting the relevant cohort based at least in part on a determination that the consumer's usage of the resource is greater than the relevant cohort's usage of the resource. Selecting the relevant cohort comprises comparing the consumer's usage to that of each of a plurality of candidate cohorts and selecting as the relevant cohort the candidate cohort to which the consumer compares least favorably.

In some embodiments, determining the relevant cohort comprises using third party data sources. For example, third party data sources may include records associated with home ownership, which are used to identify members of the relevant cohort based at least in part on information indicating such members own a home associated with their consumption of the resource.

In step 504, the consumer's usage and relevant cohort's usage of the resource are compared. The usage of the resource may be time-value curve or a statistical measure such as a mean, median, average, or aggregate usage. In some embodiments, the usage is chosen at least in part so that the consumer's usage of the resource is greater than the relevant cohort's usage of the resource.

In step 506, the comparison is communicated to the consumer. In some embodiments, the comparison is communicated to the consumer as integrated with the consumer's resource bill, standalone with the consumer's resource bill or on the resource's website under the consumer's web account. The communication includes one or more of the selected messages 306, based on both the resource account attributes 302 and feedback 308.

In some embodiments, the comparison utilizes a stochastic pricing model to enable ongoing prioritization of messages per customer as a factor of all the previous inputs into the model, including feedback and cohort data.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1.-25. (canceled)

26. A computerized method for suggesting actions to reduce a first consumer's usage of a resource, the method comprising:
in a first computer process, retrieving information about a first consumer and at least one relevant consumer, the information including at least resource usage data;
in a second computer process, comparing the first consumer's resource usage data to the at least one relevant consumer's resource usage data;
in a third computer process, selecting at least one message from a plurality of candidate messages that each suggest an action to reduce resource usage, the selection of the message being based at least in part on the comparison of the first consumer's resource usage data to the at least one relevant consumer's resource usage data; and
communicating the at least one message to the first consumer.

27. A method according to claim 26, wherein the selection of the at least one message is based, at least in part, on an action to reduce resource usage taken by the at least one relevant consumer.

28. A method according to claim 26, further comprising:
gathering feedback on the success of the candidate messages in reducing a consumer's resource usage.

29. A method according to claim 28, wherein the selection of the at least one message is based, at least in part, on success of the candidate messages in reducing a consumer's resource usage.

30. A method according to claim 28, wherein the feedback includes first consumer's and the at least one relevant consumer's resource usage.

31. A method according to claim 28, wherein the feedback includes a consumer's action taken with respect to the message.

32. A method according to claim 26, further comprising:
retrieving information about the first consumer and a plurality of second consumers, the information including housing data and resource usage data.

33. A method according to claim 32, wherein the at least one relevant consumer is selected from the plurality of second consumers based on at least two common characteristics between the first consumer's home and a second consumer's home.

34. A method according to claim 33, wherein the at least two common characteristics are location of the homes and area of the homes.

35. A method according to claim 33, wherein the at least two common characteristics are selected from the group consisting of:
location of the homes,
area of the homes,
number of bedrooms in the homes,
number of floors of the homes,
date of construction of the homes,
assessed home value of the homes,
permits issued for past renovations of the homes,
number of people living in the homes,
presence of a garage in the homes, and
presence of a pool in the homes.

36. A method according to claim 33, wherein the at least one relevant consumer is selected based, at least in part, on a determination that the first consumer's resource usage is greater than the relevant consumer's resource usage.

37. A method according to claim 26, wherein the resource usage data comprises one or more of electrical usage data and gas usage data.

38. A method according to claim 26, wherein the resource usage data comprises one or more of electrical usage data, gas usage data, waste usage data, water usage data, sewer usage data, garbage usage data, recycling usage data, phone usage data, and broadband access usage data.

39. A method according to claim 26, wherein the message is communicated over a computer network.

40. A method according to claim 26, wherein the message is communicated to the first consumer as part of the first consumer's resource bill.

41. A method according to claim 26, wherein the resource usage data includes at least one of a time value curve, a mean usage, a median usage, an average usage, and an aggregate usage.

42. A method according to claim 26, wherein selecting the message comprises assigning to each of at least a subset of the plurality of candidate messages a priority and selecting the at least one message based, at least in part, on the assigned priorities of the candidate messages.

43. A method according to claim 42, wherein the number of messages selected corresponds to a number of message locations provided in a communication to be sent to the first consumer.

44. A system for suggesting actions to reduce a first consumer's usage of a resource, the method comprising:
a data store for storing information about a first consumer and at least one relevant consumer, the information including resource usage data; and
a processor configured to retrieve information about the first consumer and the at least one relevant consumer from the data store;
wherein the processor is configured to compare the first consumer's resource usage data to the at least one relevant consumer's resource usage data and select at least one message from a plurality of candidate messages that each suggest an action to reduce resource usage, the selection of the message being based at least in part on the comparison of the first consumer's resource usage data to the at least one relevant consumer's resource usage data; and
wherein the processor is configured to communicate the at least one message to the first consumer.

45. A system according to claim 44, wherein the processor is a server.

46. A system according to claim 44, wherein the processor is configured to select the at least one message based, at least in part, on an action to reduce resource usage taken by the at least one relevant consumer.

47. A system according to claim 44, wherein the processor is in communication with a computer network and the processor is further configured to communicate the at least one message over the computer network to the first consumer.

48. A system according to claim 44, wherein the processor is further configured to retrieve information about the first consumer and a plurality of second consumers, the information including housing data and resource usage data.

49. A system according to claim 48, wherein the processor is further configured to select at least one relevant consumer from the plurality of second consumers based, at least in part, on:
at least two common characteristics between the first consumer's home and the relevant consumer's home, and
a determination that the first consumer's resource usage is greater than the relevant consumer's resource usage.

50. A system according to claim 49, wherein the at least two common characteristics are location of the homes and area of the homes.

51. A system according to claim 44, wherein the processor is further configured to select the message by assigning to each of at least a subset of the plurality of candidate messages a priority and selecting the at least one message based, at least in part, on the assigned priorities of the candidate messages.

52. A system according to claim 44, wherein the processor is further configured to receive feedback on the success of the candidate messages in reducing a consumer's resource usage.
